(19) United States
(12) Patent Application Publication
(10) Pub. No.: US 2004/0175161 A1
(43) Pub. Date: Sep. 9, 2004

(54) Heating of oak wood

(76) Inventor: Peter Warren, Willunga (AU)

Correspondence Address: COOK, ALEX, McFARRON, MANZO,, CUMMINGS & MEHLER, LTD., Suite 2850, 200 West Adams Street, Chicago, IL, 60606, US

(21) Appl. No.: 10/377,923

(22) Filed: Mar. 3, 2003

(51) Int. Cl. F26B 13/10

(52) U.S. Cl. 392/417; 392/407

(57) ABSTRACT

An apparatus and method for the controlled heating and firing of oak wood in the form of flat staves. The staves are assembled in a panel and heated by far infra red heaters passed in a controlled manner across the panel.

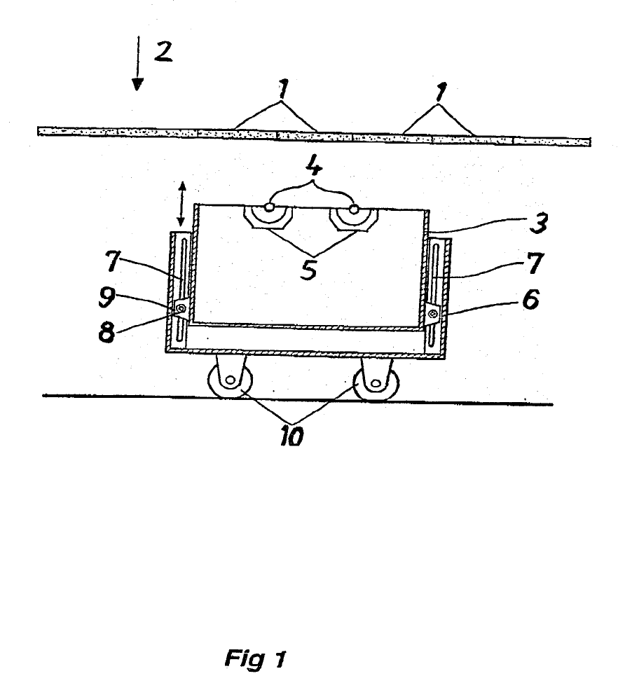

This invention relates to the heating or firing of oak wood for the wine industry.

Conventionally and for many years has been done during the coopering of the barrels by having a fire within the barrel. However this does not provide a reliable heat source, and after reviewing preliminary work in this field regarding the level of heating of oak barrels and the derived wine results, it became apparent that there was no recorded temperature information to provide a starting point. In other words, only a “heat index” could be given to the respective barrels involved in the experiments, as by the time the researchers obtained the barrels, the firing had already taken place as part of the barrel making process.

It has been found there are four important flavour volatiles such as Eugenol, Vanillin, Cis-Oak Lactone, Trans-Oak Lactone in significant quantities in unheated oak wood, and in higher amounts in heated oak wood. Vanillin is the main flavour impact in the natural vanilla. It can be extracted in significant quantity from unheated oak wood and in much higher amounts from strongly heated oak wood. Vanillin is an important contributor to the characters of barrel aged wine.

Heating oak can result in up to fifty fold increase in vanillin in oak wood. Heating produced the greatest sensory changes VIZ ‘caramel’, ‘cedar’, ‘nutty’ aromas and decreased the ‘raisin’ characters of the extracts.

Three distinct sources of variation in aroma differences are attributed to:

a Composition of oak wood prior to coopering

b The heat absorbed by the wood during coopering

c Microbial activity occurring during wine maturation.

Sensory responses associated with cis-oak lactone singles out as a most important oak aroma. Overall heat and the degree to which that heat is conducted below the wood surface is important. Cis-oak lactone in its pure form possesses a ‘coconut’ aroma in white or red wine Also variation in cis-lactone was strongly influenced by the source and also the location of seasoning of the oak. The strong association of the cis-lactone with many positive aroma qualities and the unreliable nature of quality determinants highlights the potential advantage of basing quality assurance on quantification of the four main oak compounds (pre and post heating).

A chemical change takes place in the wood during heating, and it has been found it is desirable that not only the surface of the wood be treated but also the chemical change should take place below the surface of the wood. Uniformity of heating and also the presence of moisture in the wood are desirable for the chemical change to take place. Additionally any contaminants which may arise from the heat source will affect the desired aromas. Thus if wood or gas fires are used as the heat source contaminants in the smoke of fumes given off by the fire will affect the aromas.

As the Knowledge of compositional changes in oak wood with various heat treatments and temperatures improves, it is likely that it will become easier to effect specific oak outcomes in wines.

Thus it is an object of this invention to provide a controllable heat source for the heat treatment of oak wood.

It is a further object to provide a heat source which produces no contaminants itself.

A further object is to provide a heat source which will heat the wood below the surface thereof.

Thus there is provided a method of heating or firing oak wood for the wine industry, said method including the step of heating or firing the oak wood with a far infra red heater.

It is preferred that the heating or firing includes the steps of firing the oak wood in two stages, a lower temperature stage and a second firing at a higher temperature.

It is also preferred that the wood be flat staves assembled to form a panel and the step of having relative movement between a far infra red heater and the panel so that the heating passes across the panel.

Also there is provided an apparatus for firing or heating oak wood, the apparatus comprising a far infra red heater, means for holding the oak wood, and means for passing the heater over or across the oak wood.

Preferably the oak wood is in the form of flat staves which for heating are assembled side by side.

In order to more fully describe the invention reference will now be made to the accompanying FIGURE showing one possible form of the invention.

In this example the oak wood is in the form of a form of a plurality of flat staves 1 assembled into a panel 2 supported on a frame (not shown).

Beneath the panel there is positioned a heater box 3 housing two far infra red heater bars 4 each with its reflector 5. The heater box 3 is supported in a carriage 6 by and is vertically adjustable in the carriage. The carriage as shown has vertical guides or slots in which locking studs or bolts 8 can be adjustably positioned. The heater box 3 has extending lugs 9 carrying the bolts 8. Thus the heater box can be vertically positioned in the carriage whereby the distance of the heater bars from the staves can be selected and positioned as desired. The carriage is mounted on wheels or rollers to permit the passage of the beater bars across the staves. The carriage can be driven across under the staves by any suitable drive means. For example a reversible variable speed electric motor mounted on the carriage may drive a wheel or wheels of the carriage. Alternately the carriage can be moved by a belt or chain connected to a reversible variable speed motor and drive mounted on the floor The chain or belt may be endless and the drive reversible so that a variable speed drive in both directions is available.

Thus the distance of the heaters below the panel can be varied, the speed of travel of the heater box can be varied, and the spacing between the heater bars is adjustable. Also if desired a single heater bar can be used or alternately there may be more than two. Hence these variables are available depending on the type of oak to be heated and the degree of heating required.

Additionally the temperature of each of the heater bars can be varied as desired. Also as American oak is of heavier density than French oak, the exposure time, and/or temperature and/or travel speed is to be varied.

Preferably the treatment is in two stages, firstly there is a pre heat temperature of say 100° C. This permits the necessary chemical reaction to take place and the oak is then “fired” at approximately 200° C. The wood is then stacked and permitted to recover for 3-4 days.

Process heating by far infra red heating is accomplished without the need of physical contact with the heat source or the necessity of hot air or products of combustion to carry heat from the source to the product. The energy derived from the source is transferred by invisible electromagnetic waves from the infra red source which is in the invisible far infra red wave length.

This energy is absorbed with almost equal speed by all colours and surfaces. When infra red energy strikes the staves the radiation is absorbed and converted to heat above and below the surface. This radiant energy does not heat the air appreciably and therefor requires no air for its transmission. Oak being a homogeneous structure absorbs this energy on and below the surface of the oak. This is evident by preliminary research carried out examining cross sections of samples of oak taken for depth or extent of structural change (thermal degradation) and actual changes in colour. It has been found using this type of controlled heat application shows an even depth of the heat affected zone in the oak caused by the constant energy from the source and controlled time of exposure. This is easily attainable as the surfaces to be heated are flat as opposed to barrels having curved surfaces. Therefor the distance between the heat source and the oak panels can be accurately controlled and is always constant as is the energy source and energy emitted.

Preferably the oak panels are suspended horizontally over the heating apparatus at a set distance from the elements. This reduces the amount of moisture loss from the oak during heating and provides for the efficient use of energy. Also is convenient if a heavy toasting is required as the oak panel being fired is actually enveloped in its own smoke

Preferably a highly polished reflector is formed to a parabolic shape with the heating bar at its focal point for maximum efficiency emitting a wide and even band of energy.

The energy generated from the source does not produce products of combustion, thus the staves are not contaminated by hot gas and there is no product of combustion that must be discharged

As the temperature of an infra red heater is directly proportional to the wave length emitted, perfect wave length control was achieved by connecting a thermocouple to a solid state controller. Using this control it is possible to achieve a perfect wave length from the one emitter.

In a further embodiment of the invention the staves are positioned on a conveyor to pass under a bank of heaters. The conveyor passes firstly under a bank of preheaters, preferably far infra red heaters, and then passes under the second bank of heaters to fire the oak stave. This avoids the necessity of reversing to again pass the oak wood under the same heaters for a second period of time.

The passage of the carriage or the conveyor is preferably under the control of a Program Logic control. As noted above the spacing between the wood and the heaters can be controlled, the temperature of the far infra red heaters and the speed of passage of the wood past the heaters can be all controlled.

Thus it follows that the whole system can be computer controlled to ensure finite control and uniformity of the firing of the oak. It is to be noted while the invention is particularly described with reference to the firing of oak staves, the method and apparatus can also be applied to the firing of other oak products such as chips.

Although one form of the invention has been described in some detail it is to be realised the invention is not to be limited thereto but can include variations and, modifications falling within the spirit and scope of the invention.

1. A method of heating or firing oak wood for the wine industry, said method including the step of heating or firing the oak wood with a far infrared heater.

2. A method as defined in claim 1 including the steps of firing the oak wood in two stages, a first lower temperature stage and a second firing stage at a higher temperature.

3. A method as defined in claim 1 including the steps of providing flat oak wood staves, assembling the staves to form a panel and the step of providing relative movement between a far infrared red heater and the panel so that the heat passes across the panel.

4. A method as defined in claim 2 including the steps of providing flat oak wood staves, assembling the staves to form a panel and the step of providing relative movement between a far infrared heater and the panel so that the heat passes across the panel.

5. A method as defined in claim 3 including the step of preheating the oak staves by passage of the heater across the panel and a second heating or firing of the oak staves by a second passage of the heater across the panel.

6. A method as defined in claim 4 including the step of preheating the oak staves by passage of the heater across the panel and a second heating or firing of the oak staves by a second passage of the heater across the panel.

7. A method as defined in claim 3 including the steps of mounting the panel in a frame, positioning the heater beneath the panel and moving the heater across the panel.

8. A method as defined in claim 4 including the steps of mounting the panel in a frame, positioning the heater beneath the panel and moving the heater across the panel.

9. A method as defined in claim 3 including the steps of mounting the panel in a frame, positioning the heater beneath the panel and moving the frame and panel across the heater.

10. A method as defined in claim 4 including the steps of mounting the panel in a frame, positioning the heater beneath the panel and moving the frame and panel across the heater.

11. A method as defined in any one of the preceding claims including the steps of providing the heater with one or more far infrared heaters.

12. Apparatus when used to heat or fire oak wood as defined in the method of any one of claims 1 to 10, said apparatus comprising a far infrared heater, means for holding the oak wood, and means for creating relative movement between the oak wood and the far infrared heater so that the heating effect traverses across the oak wood.

13. An apparatus as defined in claim 12, the apparatus including a frame to hold a panel of flat oak staves above said far infrared heater.

14. An apparatus as defined in claim 12 wherein the heater comprises one or more infrared heaters.

15. An apparatus as defined in claim 13 wherein the heater comprises one or more infrared heaters.

16. An apparatus as defined in claim 12 including means for moving the heater across the panel to heat the panel.

17. An apparatus as defined in claim 12 including means to vary the spacing between the heater and the panel.

18. An apparatus as defined in claim 16 wherein the heater is mounted in a carriage mounted on wheels, means for vertically adjusting the heater in the carriage to vary the spacing between the heater and the panel.

19. An apparatus as defined in claim 12 and including drive means on the carriage to move the heater across under the panel of oak wood staves.

20. An apparatus as defined in claim 12 including control means to control the speed of movement of the heaters relative to the panel.
